(19) United States
(12) Patent Application Publication
(10) Pub. No.: US 2009/0168693 A1
(43) Pub. Date: Jul. 2, 2009

(54) TECHNIQUES FOR THE OPERATION OF MULTIPLE CLASSES OF DEVICES IN A WIRELESS PERSONAL AREA NETWORK

(76) Inventors: Richard Roberts, Hillsboro, OR (US); Kris Fleming, Chandler, AZ (US); Guoqing Li, Portland, OR (US)

Correspondence Address: INTEL CORPORATION;c/o CPA Global, P.O. BOX 52050, MINNEAPOLIS, MN, 55402, US

(21) Appl. No.: 11/967,329

(22) Filed: Dec. 31, 2007

(51) Int. Cl. H04Q 7/00

(52) U.S. Cl. 370/328

(57) ABSTRACT

An embodiment of the present invention provides a method, comprising communicating and coexisting in a wireless personal area network (WPAN) by a at least one device operating as an advanced device (AD) and at least one device operating as a simple device (SD) by using the at least one AD as a proxy for the at least one SD to control the communication of the at least one SD.

### BACKGROUND

Currently, in standards development in Wireless Personal Area Networks (WPAN), such as, but not limited to, the TC32-TG20—High Rate Short Range Wireless Communication committee, there are multiple types of devices being discussed. Specifically, there is a first type of device called an “advanced device” (AD) which is focused on video streaming at a longer range and high antenna gain and has complex MAC functionality. Another type of device is called a “simple device” (SD) which is targeted at point-n-shoot applications, low power operation, minimum signal processing capability and minimum MAC functionality. Due to mutual interference, it is difficult for these two types of devices to co-exist and be interposable.

Thus, a strong need exists for techniques for the operation of multiple classes of devices in a wireless personal area network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates one example for SD and AD operations according to an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

An embodiment of the present invention provides a method for two or more devices to co-exist and communicate with each other using AD devices as a proxy and to reserve the channel time. An assumption of this embodiment provides that the AD and the SD are sharing the same channel, which in a typical embodiment is usually a frequency channel. The SD will be limited either by reduced Equivalent Isotropic Radiated Power (EIRP) or reduced transmit power in order for low cost. Set forth below is a summary of the characteristics of each type of device.

Simple Device (SD)

Focused on Point to Point, Low power, Inexpensive, Minimum MAC

Examples: Phone, PDA, iPod, etc.

Advance Device (AD)

Focused on WPAN usage model, Longer Range, Improved Spatial Reuse, Full MAC

Examples: Set-top Box to TV, Notebook to Peripheral.

Embodiments of the present invention provide using an AD device as a proxy to control the communication of the SD devices. The procedure of the communication between AD and SD includes the AD performing at least the in band MAC for device discovery, reservation, etc. The SD device requires an AD device to be present to be a surrogate to set up the WPAN, beacon, reserve time for SD devices to communicate with the AD device and the SD device communication and interference range is less than an AD device.

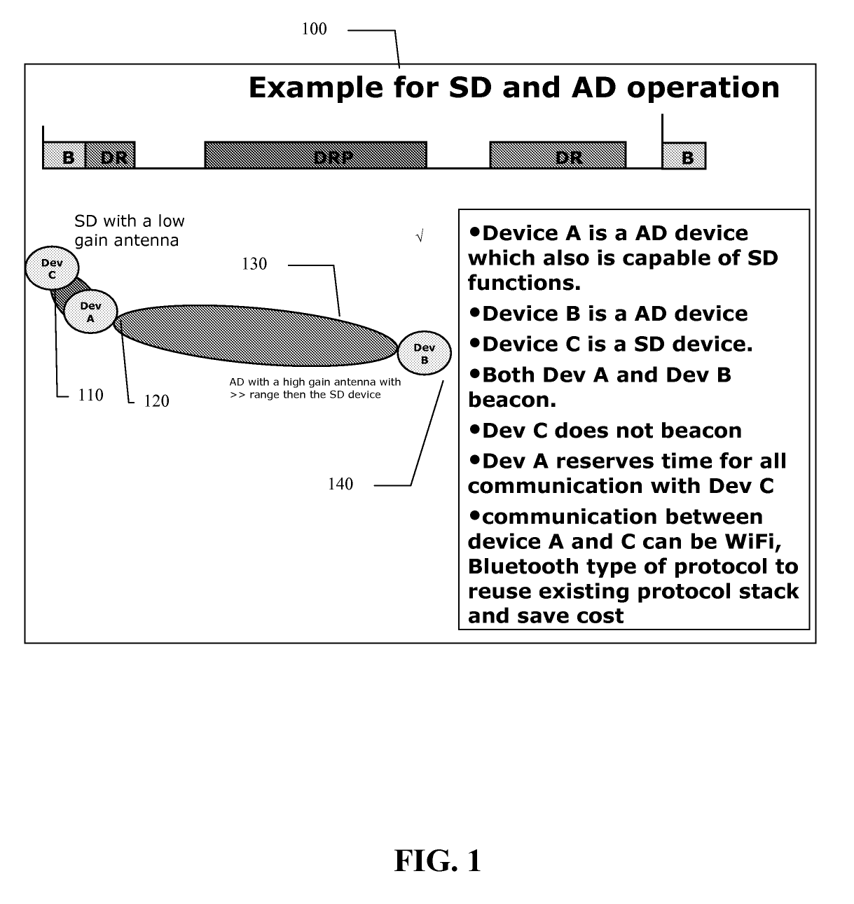

Turning now to FIG. 1 at 100 is an illustration of one example for SD and AD operations according to an embodiment of the present invention. FIG. 1 illustrates how the channel is reserved and how communication between SD and AD devices is accomplished. In the beginning, device A and B participate in a beacon period to negotiate their channel time (i.e., DRP distributed reservation protocol reservation). Once device A confirms its channel reservation, it'll use this time for the private communication with the SD devices. The protocol of how AD and SD devices communicate can be any existing protocol such as WiFi, Bluetooth etc. through SD's PHY waveform—although the present invention is not limited in this respect.

In the illustrative embodiment of FIG. 1, Device A 120 is an AD device that is also capable of SD functions. Device B 140 is an AD device and device C 110 is a SD device. Device A 120 and device B 140 both provide beacon functionality while device C 110 does not. Device A 120 reserves time for all communications with device C 110. As stated above, in an embodiment of the present invention, but not limited in this respect, communication between device A and C can be WiFi (IEEE 802.11) or Bluetooth type of protocol to reuse existing protocol stack and save costs.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method, comprising:
communicating and coexisting in a wireless personal area network (WPAN) by at least one device operating using advanced device (AD) and at least one device operating by simple device (SD) by using said at least one AD as a proxy for said at least one SD to control the communication of said at least one SD.

2. The method of claim 1, wherein said at least one AD performs in band MAC functions and said AD and said SD operate on the same frequency.

3. The method of claim 2, wherein said in-band MAC functions include device discovery and reservations.

4. The method of claim 1, wherein said at least one SD requires an AD to be present to be a surrogate to set up the WPAN, Beacon and reserve time for said at least one SD to communicate with said at least one AD.

5. The method of claim 1, wherein said at least one SD communication and interference range is required to be less than said at least one AD.

6. A WPAN system, comprising:
at least one device operating in said WPAN using advanced device (AD); and
at least one device operating in said WPAN by simple device (SD), wherein said at least one SD uses said at least one AD as a proxy to control the communication of said at least one SD to enable communicating and coexisting in said wireless personal area network (WPAN).

7. The system of claim 6, wherein said at least one AD performs in band MAC functions.

8. The system of claim 7, wherein said in-band MAC functions include device discovery and reservations.

9. The system of claim 6, wherein said at least one SD requires an AD to be present to be a surrogate to set up the WPAN, Beacon and reserve time for said at least one SD to communicate with said at least one AD.

10. The system of claim 6, wherein said at least one SD communication and interference range is required to be less than said at least one AD.

11. An apparatus, comprising:
a first transceiver operable in a wireless personal area network (WPAN) operating as a simple device (SD), wherein said first transceiver uses a second transceiver operable in said WPAN that is operating as an advanced device (AD) as a proxy to control the communication of said first transceiver to enable coexistence in said WPAN.

12. The apparatus of claim 11, wherein said second transceiver performs in band MAC functions.

13. The apparatus of claim 12, wherein said in-band MAC functions include device discovery and Reservations.

14. The apparatus of claim 11, wherein said first transceiver requires said second transceiver to be present to be a surrogate to set up the WPAN, Beacon and reserve time for said first transceiver to communicate with said second transceiver.

15. The apparatus of claim 11, wherein said first transceiver communication and interference range is required to be less than said second transceiver.
